(19) United States
(12) Patent Application Publication
(10) Pub. No.: US 2021/0311362 A1
(43) Pub. Date: Oct. 7, 2021

(54) LIGHTING DEVICE AND DISPLAY DEVICE

(71) Applicant: Japan Display Inc., Tokyo (JP)

(72) Inventors: Junji KOBASHI, Tokyo (JP); Takeo KOITO, Tokyo (JP)

(73) Assignee: Japan Display Inc., Tokyo (JP)

(21) Appl. No.: 17/216,855

(22) Filed: Mar. 30, 2021

(30) Foreign Application Priority Data
Apr. 1, 2020 (JP) 2020-065646

(51) Int. Cl. G02F 1/1335; G02F 1/13357

(52) U.S. Cl. CPC G02F 1/133607; G02F 1/13362

(57) ABSTRACT

The lighting device includes a light source, a geometric phase lens over the light source, and a variable phase difference element over the geometric phase lens. The geometric phase lens is configured to separate into a first light having a focal length +f and a second light having a focal length −f. The variable phase difference element is configured to convert a polarization state of each of the first light and the second light.

### CROSS REFERENCE TO RELATED APPLICATIONS

This application is based on and claims the benefit of priority from the prior Japanese Patent Application No. 2020-065646, filed on Apr. 1, 2020, the entire contents of which are incorporated herein by reference.

### FIELD

An embodiment of the present invention relates to a lighting device. Also, an embodiment of the present invention relates to a display device. Also, an embodiment of the present invention relates to a backlight.

### BACKGROUND

A liquid crystal display device is a display device that uses liquid crystals and a light source. In the liquid crystal display device, an arrangement of the liquid crystals is changed by applying a voltage to the liquid crystals. A light emitted from the light source is transmitted or shielded due to the different in the arrangement of the liquid crystals. In other words, the liquid crystal display device uses the liquid crystals as a switch to control the transmission or non-transmission of light emitted from the light source.

For the liquid crystal display device, it is important not only to have excellent display quality but also to reduce power consumption. Since most of the electric power of the liquid crystal display device is consumed by the light source, technological development for reducing the power consumption of the light source is underway. Local dimming technology is known as a technology for high contrast of display and low power consumption of the light source. This technology divides the light source into a plurality of regions and adjusts the brightness of the light source for each divided region. Since the light source can be turned off in the area not used for display, the power consumption of the light source can be reduced. In addition, the local dimming technology can reduce the brightness of the black display by turning off the light source, so that the display can have high contrast.

On the other hand, polarized light is often used as the light source of the liquid crystal display device. As a method of converting the polarization state of light, a method using a geometric phase element is known (see, for example, Japanese Patent Application Laid-Open No. 2016-591327).

### SUMMARY

The lighting device according to an embodiment of the present invention includes a light source, a geometric phase lens over the light source, and a variable phase difference element over the geometric phase lens. The geometric phase lens is configured to separate an incident light into a first light having a focal length +f and a second light having a focal length −f. The variable phase difference element is configured to convert a polarization state of each of the first light and the second light.

Further, a display device according to an embodiment of the present invention includes at least one lighting device and a display panel over the at least one lighting device. The at least one lighting device includes a light source, a geometric phase lens over the light source, and a variable phase difference element over the geometric phase lens. The geometric phase lens is configured to separate an incident light into a first light having a focal length +f and a second light having a focal length −f. The variable phase difference element is configured to convert a polarization state of each of the first light and the second light. The display panel is arranged to face the at least one lighting device.

Furthermore, a display device according to an embodiment of the present invention includes a display panel, a plurality of geometric phase lenses arranged to face the display panel, at least one variable phase difference element between the display panel and the plurality of geometric phase lenses, and at least one light source configured to irradiate the light incident on the plurality of geometric phase lenses. The at least one variable phase difference element is configured to vary a phase difference of a light.

### BRIEF DESCRIPTION OF DRAWINGS

FIG. 1A is a schematic cross-sectional view of a lighting device according to an embodiment of the present invention,

FIG. 1B is a schematic cross-sectional view of a lighting device according to an embodiment of the present invention,

FIG. 1C is a diagram showing an orientation distribution of a uniaxial anisotropic material of GP lens of a lighting device according to an embodiment of the present invention,

FIG. 2A is a schematic cross-sectional view of a lighting device according to an embodiment of the present invention,

FIG. 2B is a schematic cross-sectional view of a lighting device according to an embodiment of the present invention,

FIG. 2C is a schematic cross-sectional view of a lighting device according to an embodiment of the present invention,

FIG. 3A is a schematic cross-sectional view of a lighting device according to an embodiment of the present invention,

FIG. 3B is a schematic cross-sectional view of a lighting device according to an embodiment of the present invention,

FIG. 4A is a schematic cross-sectional view of a lighting device according to an embodiment of the present invention,

FIG. 4B is a schematic cross-sectional view of a lighting device according to an embodiment of the present invention,

FIG. 5A is a schematic cross-sectional view of a lighting device according to an embodiment of the present invention,

FIG. 5B is a schematic cross-sectional view of a lighting device according to an embodiment of the present invention,

FIG. 6A is a schematic cross-sectional view of a lighting device according to an embodiment of the present invention,

FIG. 6B is a schematic cross-sectional view of a lighting device according to an embodiment of the present invention,

FIG. 7 is a schematic cross-sectional view of a lighting device according to an embodiment of the present invention.

FIG. 8 is a schematic cross-sectional view of a lighting device according to an embodiment of the present invention,

FIG. 9A is a schematic cross-sectional view of a display device according to an embodiment of the present invention,

FIG. 9B is a schematic cross-sectional view of a display device according to an embodiment of the present invention,

FIG. 10 is a schematic plan view of a display device according to an embodiment of the present invention,

FIG. 11 is a cross-sectional view of a display area of a display device according to an embodiment of the present invention,

FIG. 12 is a schematic cross-sectional view of a transistor included in a display device according to an embodiment of the present invention, and

FIG. 13 is a circuit diagram of a pixel circuit in a pixel of a display device according to an embodiment of the present invention.

### DESCRIPTION OF EMBODIMENTS

Light from the light source has some spread. Therefore, in the local dimming drive of the liquid crystal display device, a phenomenon called halo, in which light leaks not only to the area where the light source is turned on, but also to the periphery of the turned on the area due to the spread of light, has been a problem. Therefore, there has been a need for a method and a lighting device that can control the light emitted from a light source while suppressing the spread of light.

In view of the above problems, it is one object of an embodiment of the present invention to provide a lighting device that can control a light emitted from a light source. Further, it is one object of an embodiment of the present invention to provide a display device that can control a light emitted from a light source. Furthermore, it is one object of an embodiment of the present invention to provide a backlight that can control a light emitted from a light source.

Each embodiment of the present invention is explained below while referring to the drawings. However, the present invention can be implemented in various modes without departing from the gist of the invention and should not be interpreted as being limited to the description of the embodiments exemplified below.

Although the drawings may be schematically represented in terms of width, thickness, shape, and the like of each part as compared with their actual mode in order to make explanation clearer, it is only an example and an interpretation of the present invention is not limited. In addition, in the drawings, the same reference numerals are provided to the same elements as those described above with reference to preceding figures and repeated explanations may be omitted accordingly.

In the case when a single film is processed to form a plurality of structural bodies, each structural body may have different functions and roles, and the bases formed beneath each structural body may also be different. However, the plurality of structural bodies are derived from films formed in the same layer by the same process and have the same material. Therefore, the plurality of these films is defined as existing in the same layer.

When expressing a mode in which another structure is arranged above a certain structure, in the case where it is simply described as “over” or “above”, unless otherwise noted, a case where another structure is arranged directly above a certain structure as if in contact with that structure, and a case where another structure is arranged via another structure above a certain structure, are both included.

In each embodiment of the present invention, as a general rule, a direction in which a light emitted from a light source is directed is described as “over” or “above” and is also shown.

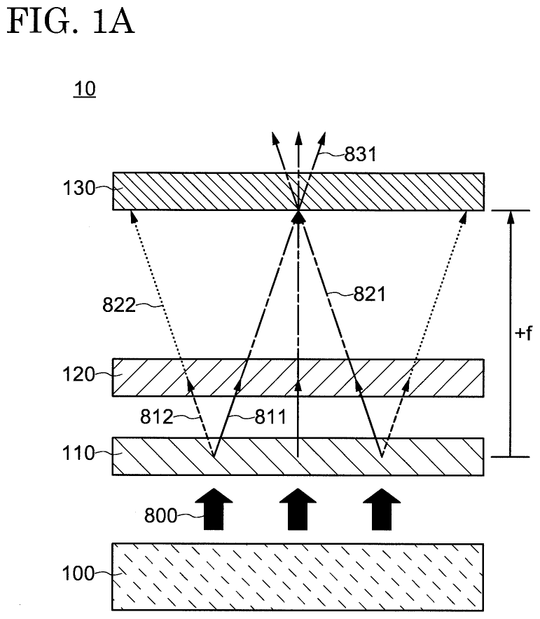

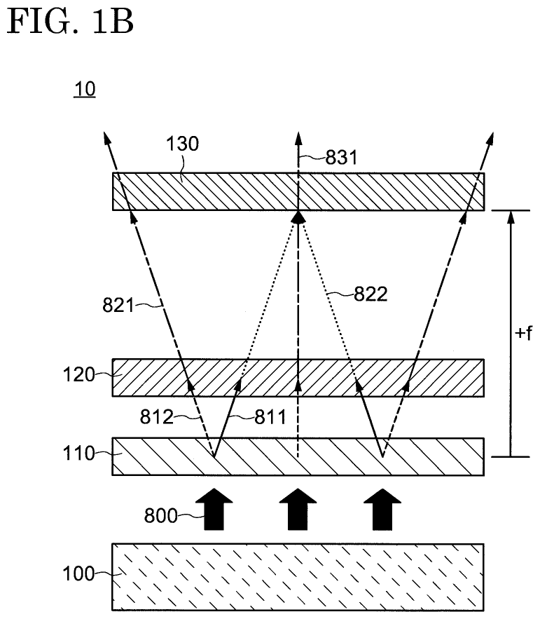

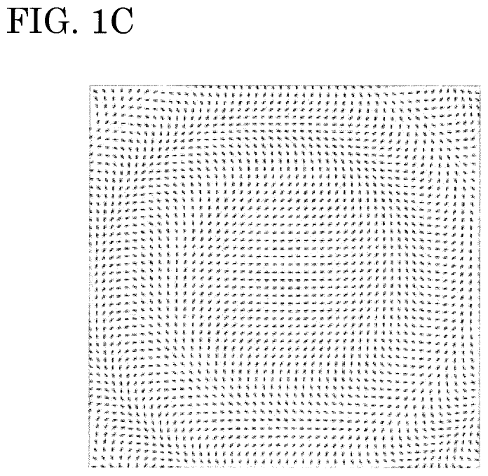

Referring to FIGS. 1A to 1C, a lighting device 10 according to an embodiment of the present invention is described.

FIGS. 1A and 1B is schematic cross-sectional views of the lighting device 10 according to the embodiment of the present invention, respectively. As shown in FIGS. 1A and 1B, the lighting device 10 includes a light source 100, a geometric phase lens 110 (hereinafter referred to as “GP lens 110”), a variable phase difference element 120, and a polarizer 130. The GP lens 110, the variable phase difference element 120, and the polarizer 130 are provided above the light source 100 in this order. That is, the GP lens 110 is provided directly above the light source 100.

The light source 100 has a function of emitting light. As the light source 100, for example, a light bulb, a fluorescent lamp, a cold cathode tube, a light emitting diode (LED), a laser diode (LD), or the like can be used. Preferably, the light source 100 of the lighting device 10 is the LED. The lighting device 10 using the LED having high luminous efficiency as the light source 100 has high brightness and low power consumption. The LED includes an organic light emitting diode (OLED), and the LD includes an organic laser diode (OLD).

Further, the light source 100 may include an optical element for making the brightness of the light emitting surface uniform. As the optical element included in the light source 100, for example, a light guide plate or a diffusion plate can be used.

The GP lens 110 functions as a lens that converges or diffuses the light from the light source 100. Here, the geometric phase (GP) refers to a phase difference that occurs when a uniaxially anisotropic material is arranged by spatially rotating the optical axis of the material.

Linearly polarized light can be thought of as the sum of two circularly polarized lights, that is, right-handed and left-handed circularly polarized light. Here, consider a case where linearly polarized light transmits through a uniaxially anisotropic material having a polarization direction of 0° with respect to the optical axis and having a phase difference of ½ wavelength. In this case, the right-handed circularly polarized light and the left-handed circularly polarized light transmitted through the uniaxially anisotropic material are changed into a right-handed circularly polarized light and a left-handed circularly polarized light, respectively, by adjusting the phase difference of ½ wavelength. Further, consider a case where linearly polarized light transmits through a uniaxial anisotropic material having a polarization direction of θ° with respect to the optical axis and having a phase difference of ½ wavelength. In this case, the left-handed circularly polarized light is converted into a right-handed circularly polarized light having a phase difference of +2θ, and the right-handed circularly polarized light is converted into a left-handed circularly polarized light having a phase difference of −2θ. The GP lens 110 utilizes this property, and the uniaxially anisotropic material is geometrically oriented and arranged in a plane so that the lens is formed.

FIG. 1C is a diagram showing an orientation distribution of a uniaxial anisotropic material of the GP lens 110 of the lighting device 10 according to the embodiment of the present invention. Specifically, FIG. 1C is a diagram showing the orientation direction of the uniaxially anisotropic material obtained by a simulation. When the GP lens 110 shown in FIG. 1C is irradiated with light, different lens effects appear between the right-handed circularly polarized light and the left-handed circularly polarized light. For example, it can function as a lens having a focal length +f for the right-handed circularly polarized light, and it can function as a lens having a focal length −f for the left-handed circularly polarized light. In other words, the GP lens 110 can be said to have a function of separating the light from the light source into light of right circular polarization having a focal length +f and light of left circular polarization having a focal length −f.

As the uniaxial anisotropic material of the GP lens 110, for example, a liquid crystal can be used. In particular, a nematic liquid crystal is suitable for the uniaxial anisotropic material. The liquid crystal molecules of the GP lens 110 are geometrically oriented as shown in FIG. 1C. The liquid crystal molecules may be oriented by a photo-orientation or may be oriented by forming irregularities on a base film. When forming the irregularities on the substrate, for example, photolithography can be used.

The variable phase difference element 120 has a function of giving a phase difference to light. In other words, it can be said that the variable phase difference element 120 can adjust the phase difference of light and change the polarization state of light.

When the variable phase difference element 120 has a phase difference of ¼ wavelength (that is, the variable phase difference element 120 is a ¼ wavelength plate) and the incident light on the variable phase difference element 120 is right-handed circularly polarized light, light emitted from the variable phase difference element 120 is linearly polarized light of θ=+45°. That is, the variable phase difference element 120 changes the polarization state of light from the right-handed circular polarized light to the linearly polarized light of θ=+45°. Further, when the variable phase difference element 120 has a phase difference of ¾ wavelength and the incident light on the variable phase difference element 120 is right-handed circularly polarized light, light emitted from the variable phase difference element 120 is linearly polarized light of θ=−45°. That is, the variable phase difference element 120 changes the polarization state of light from the right-handed circular polarized light to the linearly polarized light of θ=−45°. Here, the direction of θ=0° can be considered as the slow axis of the ¼ wave plate.

The same applies when the incident light is left-handed circularly polarized light. When the variable phase difference element 120 has a phase difference of ¼ wavelength and the incident light on the variable phase difference element 120 is left-handed circularly polarized light, light emitted from the variable phase difference element 120 is linearly polarized light of θ=−45°. That is, the variable phase difference element 120 changes the polarization state of light from the left-handed circular polarized light to the linearly polarized light of θ=−45°. Further, when the variable phase difference element 120 has a phase difference of ¾ wavelength and the incident light on the variable phase difference element 120 is left-handed circularly polarized light, light emitted from the variable phase difference element 120 is linearly polarized light of θ=+45°. That is, the variable phase difference element 120 changes the polarization state of light from the left-handed circular polarized light to the linearly polarized light of θ=+45°.

As described above, when the variable phase difference element 120 has the phase difference of ¼ wavelength, the light is converted from the right-handed circularly polarized light to the linearly polarized light of θ=+45°, and from the left-handed circularly polarized light to the linearly polarized light of 0=−45°. In contrast, when the variable phase difference element 120 has the phase difference of ¾ wavelength, the light is converted from the right-handed circularly polarized light to the linearly polarized light of θ=−45°, and from the left-handed circularly polarized light to the linearly polarized light of θ=+45°. Therefore, the polarization state of the linearly polarized light of the emitted light can be controlled by switching the variable phase difference element 120 between the phase difference of ¼ wavelength and the phase difference of ¾ wavelength. Further, even if the variable phase difference element 120 has the phase difference of ¼ wavelength or the phase difference of ¾ wavelength, the right-handed circularly polarized light and the left-handed circularly polarized light are converted to the linearly polarized light having the phase difference of ½ wavelength.

The variable phase difference element 120 may have a configuration of switching between a phase difference of ¼ wavelength and a phase difference of ¾ wavelength or a configuration of switching between a phase difference of 0 wavelength and a phase difference of ½ wavelength, and may further have a configuration in which it is combined with a fixed phase difference plate having a ¼ wavelength.

As the variable phase difference element 120, for example, a liquid crystal can be used. The birefringence of the liquid crystal changes when a voltage is applied. Therefore, the phase difference of the variable phase difference element 120 can be controlled by utilizing the change in the birefringence of the liquid crystal. As the liquid crystal material, for example, an organic polymer material having an orientation such as a nematic phase, a smectic phase, a cholesteric phase, or a discotic phase can be used.

The variable phase difference element 120 may have a configuration that can continuously change the phase difference from ¼ wavelength to ¾ wavelength. In this case, the light emitted from the variable phase difference element 120 can be changed to an ellipse in which the right-handed circularly polarized light and the left-handed circularly polarized light are mixed.

The polarizer 130 has a function of transmitting linearly polarized light that oscillates in a specific direction. For example, the polarizer 130 can be arranged so as to transmit a linearly polarized light of θ=+45°. In this case, if the light incident on the polarizer 130 is linearly polarized light of θ=+45°, the light transmits through the polarizer 130 and is emitted to the outside. On the other hand, if the light incident on the polarizer 130 is linearly polarized light of θ=−45°, the light does not transmit through the polarizer 130 and is not emitted to the outside.

As the polarizer 130, for example, a uniaxially stretched polyvinyl alcohol (PVA) film or a wire grid using fine metal wires can be used.

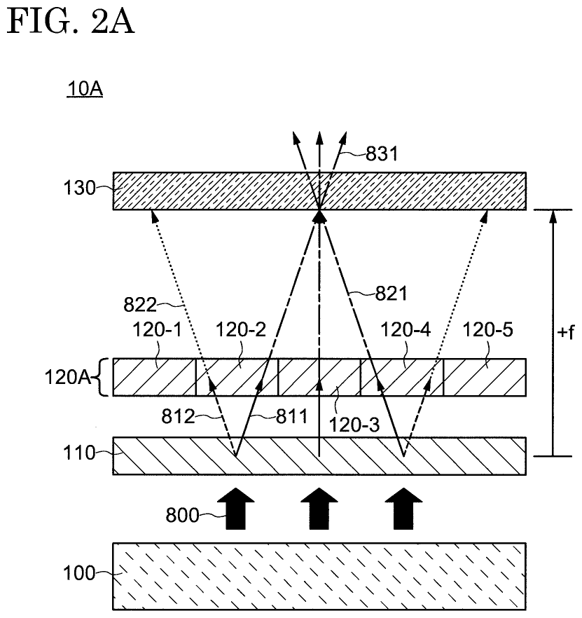

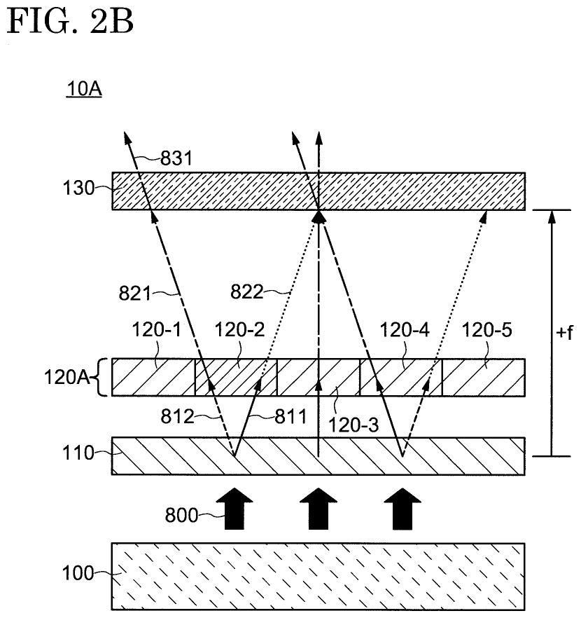

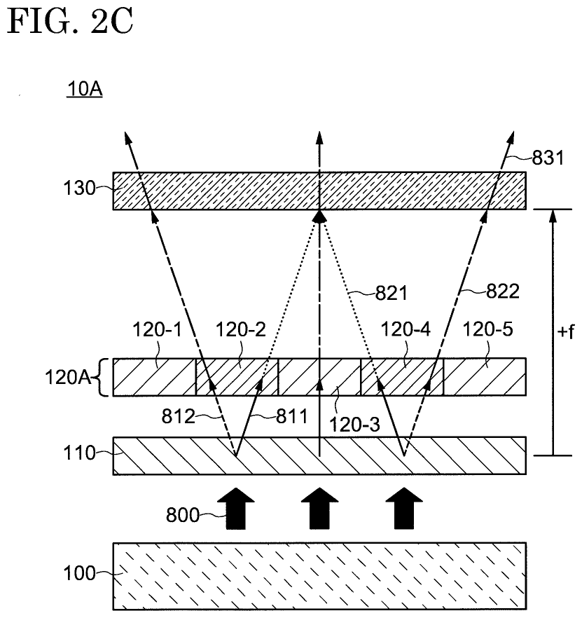

Further, referring to FIGS. 1A and 2A. In FIG. 1A, the light 831 emitted from the lighting device 10 is described. In FIG. 1A, the variable phase difference element 120 has a phase difference of ¼ wavelength, and the polarizer 130 can transmit linearly polarized light of θ=+45°.

The light 800 emitted from the light source 100 is incident on the GP lens 110. The incident light is separated into right-handed circularly polarized light 811 and left-handed circularly polarized light 812 by the GP lens 110. Further, the right-handed circularly polarized light 811 is focused to a focal length +f by the GP lens 110. On the other hand, the left-handed circularly polarized light 812 is focused to a focal length −f (not shown) by the GP lens 110, but the left-handed circularly polarized light 812 is diffused on the variable phase difference element 120 side. When the right-handed circularly polarized light 811 and the left-handed circularly polarized light 812 are incident on the variable phase difference element 120, the right-handed circularly polarized light 811 and the left-handed circularly polarized light 812 are converted into linearly polarized light 821 of θ=+45° and linearly polarized light 822 of θ=−45°, respectively, by the variable phase difference element 120. Since the linearly polarized light 821 of θ=+45° can transmit through the polarizer 130, light 831 transmitted through the polarizer 130 is emitted to the outside of the polarizer 130. On the other hand, the linearly polarized light 822 of θ=−45° cannot transmit through the polarizer 130. Therefore, the light 831 from the lighting device 10 is light based on the right-handed circularly polarized light 811 and is focused to the vicinity of the focal length +f and emitted to the outside.

Next, as shown in FIG. 1B, the variable phase difference element 120 is controlled so as to have a phase difference of ¾ wavelength. When the right-handed circularly polarized light 811 and the left-handed circularly polarized light 812 are incident on the variable phase difference element 120, the right-handed circularly polarized light 811 and the left-handed circularly polarized light 812 are converted into linearly polarized light 821 of θ=−45° and linearly polarized light 822 of θ=+45°, respectively, by the variable phase difference element 120. Since the linearly polarized light 821 of θ=+45° can transmit through the polarizer 130, light 831 transmitted through the polarizer 130 is emitted to the outside of the polarizer 130. On the other hand, the linearly polarized light 822 of θ=−45° cannot transmit through the polarizer 130. Therefore, the light 831 from the lighting device 10 is light based on the left-handed circularly polarized light 812 and is diffused and emitted to the outside.

As described above, the lighting device 10 can switch between the focused emitted light and the diffused emitted light by controlling the variable phase difference element 120. For example, the lighting device 10 can emit the focused light to irradiate a partial range brightly. Further, the lighting device 10 can emit the diffused light to irradiate a wide range.

The lighting device 10 according to the present embodiment is not limited to the above-described configuration. Therefore, some modification examples of the lighting device 10 is described in the following.

### Modification Example 1

Referring to FIGS. 2A to 2C, a lighting device 10A according to an embodiment of the present invention is described.

FIGS. 2A to 2C are schematic cross-sectional views of the lighting device 10A according to the embodiment of the present invention, respectively. As shown in FIGS. 2A to 2C, the lighting device 10A includes the light source 100, the GP lens 110, a variable phase difference element unit 120A, and the polarizer 130. The GP lens 110, the variable phase difference element unit 120A, and the polarizer 130 are provided above the light source 100 in this order. That is, the GP lens 110 is provided directly above the light source 100.

The variable phase difference element unit 120A shown in FIGS. 2A to 2C includes a plurality of variable phase difference elements 120. That is, the variable phase difference element unit 120A includes a first variable phase difference element 120-1, a second variable phase difference element 120-2, a third variable phase difference element 120-3, and a fourth variable phase difference element. Includes 120-4, and a fifth variable phase difference element 120-5. The number of variable phase difference elements 120 included in the variable phase difference element unit 120A may be more than five.

In FIG. 2A, the variable phase difference elements 120 included in the variable phase difference element unit 120A have a phase difference of ¼ wavelength, and the polarizer 130 can transmit linearly polarized light of θ=+45°

The light 800 emitted from the light source 100 is incident on the GP lens 110. The incident light is separated into the right-handed circularly polarized light 811 and the left-handed circularly polarized light 812 by the GP lens 110. Further, the right-handed circularly polarized light 811 is focused to a focal length +f by the GP lens 110. On the other hand, the left-handed circularly polarized light 812 is focused to a focal length −f (not shown) by the GP lens 110, but the left-handed circularly polarized light 812 is diffused on the variable phase difference element unit 120A side. When the right-handed circularly polarized light 811 and the left-handed circularly polarized light 812 are incident on the variable phase difference elements 120 included in the variable phase difference element unit 120A, the right-handed circularly polarized light 811 and the left-handed circularly polarized light 812 are converted into the linearly polarized light 821 of θ=+45° and the linearly polarized light 822 of θ=−45°, respectively, by the variable phase difference elements 120. Since the linearly polarized light 821 of θ=+45° can transmit through the polarizer 130, the light 831 transmitted through the polarizer 130 is emitted to the outside of the polarizer 130. On the other hand, the linearly polarized light 822 of θ=−45° cannot transmit through the polarizer 130. Therefore, the light 831 from the lighting device 10A is light based on the right-handed circularly polarized light 811 and is focused to the vicinity of the focal length +f and emitted to the outside.

Next, as shown in FIG. 2B, the second variable phase difference element 120-2 is controlled so as to have a phase difference of ¾ wavelength. When the right-handed circularly polarized light 811 and the left-handed circularly polarized light 812 are incident on the second variable phase difference element 120-2, the right-handed circularly polarized light 811 and the left-handed circularly polarized light 812 are converted into the linearly polarized light 821 of θ=−45° and the linearly polarized light 822 of θ=+45°, respectively, by the second variable phase difference element 120-2. Since the linearly polarized light 821 of θ=+45° can transmit through the polarizer 130, the light 831 transmitted through the polarizer 130 is emitted to the outside of the polarizer 130. On the other hand, the linearly polarized light 822 of θ=−45° cannot transmit through the polarizer 130. Therefore, the light 831 from the lighting device 10A is light based on not only the right-handed circularly polarized light that is transmitted through the first variable phase difference element 120-1, the third variable phase difference element 120-3, the fourth variable phase difference element 120-4, and the fifth variable phase difference element 120-5 but also the left-handed circularly polarized light 812 that is transmitted through the second variable phase difference element 120-2, and emitted to the outside.

In addition, as shown in FIG. 2C, the fourth variable phase difference element 120-4 is controlled so as to have a phase difference of ¾ wavelength. When the right-handed circularly polarized light 811 and the left-handed circularly polarized light 812 are incident on the fourth variable phase difference element 120-4, the right-handed circularly polarized light 811 and the left-handed circularly polarized light 812 are converted into the linearly polarized light 821 of θ=−45° and the linearly polarized light 822 of θ=+45°, respectively, by the fourth variable phase difference element 120-4. Since the linearly polarized light 821 of θ=+45° can transmit through the polarizer 130, the light 831 transmitted through the polarizer 130 is emitted to the outside of the polarizer 130. On the other hand, the linearly polarized light 822 of θ=−45° cannot transmit through the polarizer 130. Therefore, the light 831 from the lighting device 10A is light based on not only the right-handed circularly polarized light that are transmitted through the first variable phase difference element 120-1, the third variable phase difference element 120-3, and the fifth variable phase difference element 120-5 but also the left-handed circularly polarized light 812 that is transmitted through the second variable phase difference element 120-2 and the fourth variable phase difference element 120-4, and emitted to the outside.

As described above, the lighting device 10A can switch between the focused emitted light and the diffused emitted light while controlling the emission position of the light by controlling the variable phase difference elements 120 included in the variable phase difference element unit 120A. For example, the lighting device 10A can control so as not to partially irradiate light.

### Modification Example 2

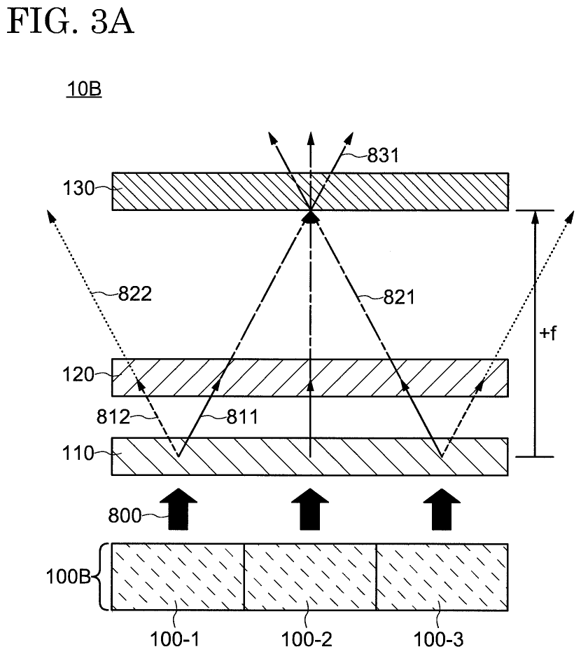

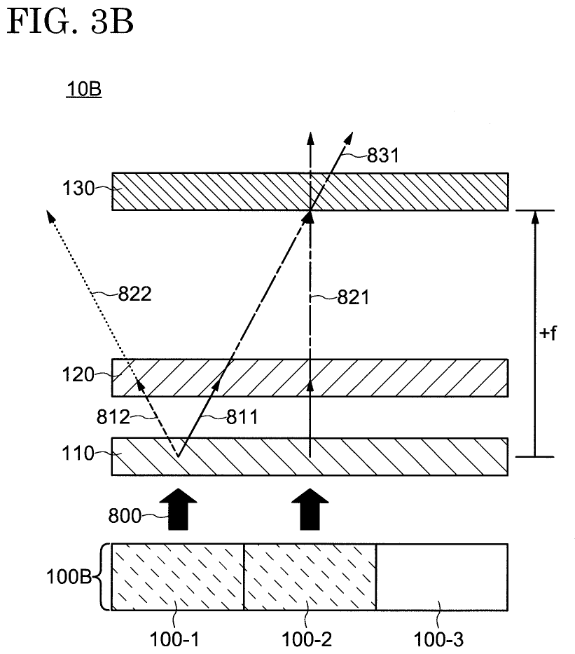

Referring to FIGS. 3A and 3B, a lighting device 10B according to an embodiment of the present invention is described.

FIGS. 3A and 3B are schematic cross-sectional views of the lighting device 10B according to the embodiment of the present invention, respectively. As shown in FIGS. 3A and 3B, the lighting device 10B includes a light source unit 100B, the GP lens 110, the variable phase difference element 120, and the polarizer 130. The GP lens 110, the variable phase difference element 120, and the polarizer 130 are provided above the light source unit 100B in this order. That is, the GP lens 110 is provided directly above the light source unit 100B.

The light source unit 100B shown in FIGS. 3A and 3B includes a plurality of light sources 100. That is, the light source 100B includes a first light source 100-1, a second light source 100-2, and a third light source 100-3. The number of light sources 100 included in the light source unit 100B may be more than three.

In FIG. 3A, the variable phase difference element 120 has a phase difference of ¼ wavelength, and the polarizer 130 can transmit linearly polarized light of θ=+45°

The light 800 emitted from the light source unit 100B is incident on the GP lens 110. The incident light is separated into the right-handed circularly polarized light 811 and the left-handed circularly polarized light 812 by the GP lens 110. Further, the right-handed circularly polarized light 811 is focused to a focal length +f by the GP lens 110. On the other hand, the left-handed circularly polarized light 812 is focused to a focal length −f (not shown) by the GP lens 110, but the left-handed circularly polarized light 812 is diffused on the variable phase difference element 120 side. When the right-handed circularly polarized light 811 and the left-handed circularly polarized light 812 are incident on the variable phase difference element 120, the right-handed circularly polarized light 811 and the left-handed circularly polarized light 812 are converted into the linearly polarized light 821 of θ=+45° and the linearly polarized light 822 of θ=−45°, respectively, by the variable phase difference element 120. Since the linearly polarized light 821 of θ=+45° can transmit through the polarizer 130, the light 831 transmitted through the polarizer 130 is emitted to the outside of the polarizer 130. On the other hand, the linearly polarized light 822 of θ=−45° cannot transmit through the polarizer 130. Therefore, the light 831 from the lighting device 10B is light based on the right-handed circularly polarized light 811 and is focused to the vicinity of the focal length +f and emitted to the outside.

The configuration of the lighting device 10B when the variable phase difference element 120 is controlled so as to have a phase difference of ¾ wavelength is the same as that of the lighting device 10, and thus the description thereof is omitted.

Next, as shown in FIG. 3B, the third light source 100-3 is turned off. Since the light emitted from the third light source 100-3 disappears, the amount of light 831 focused on the vicinity of the focal length +f and emitted becomes small.

As described above, the lighting device 10B can switch between the focused emitted light and the diffused emitted light while controlling the amount of emitted light by controlling the lighting and extinguishing of the light sources 100 included in the light source unit 100A. For example, the lighting device 10B can control the amount of light by partially irradiating light or diffusing light.

### Modification Example 3

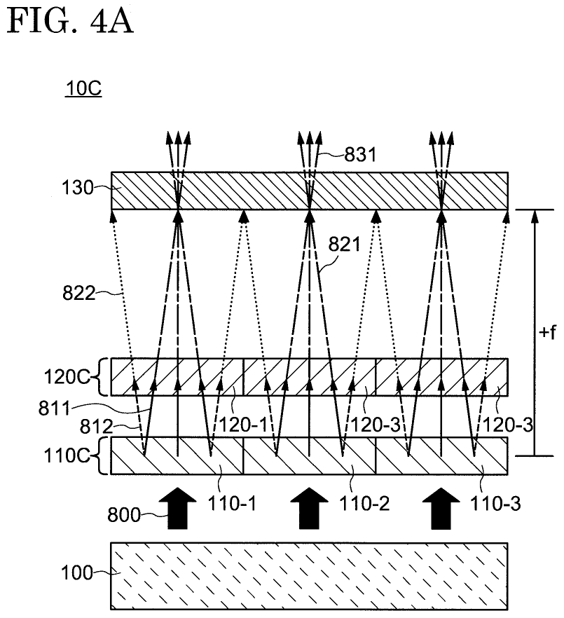

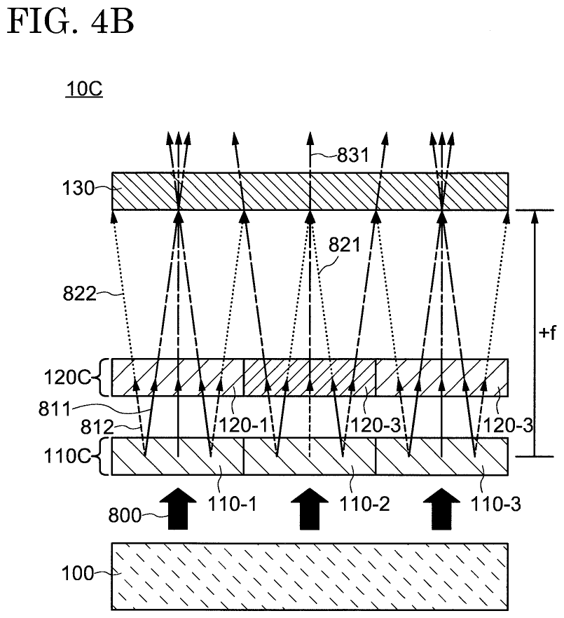

Referring to FIGS. 4A and 4B, a lighting device 10C according to an embodiment of the present invention is described.

FIGS. 4A and 4B are schematic cross-sectional views of the lighting device 10C according to the embodiment of the present invention, respectively. As shown in FIGS. 4A and 4B, the lighting device 10C includes a light source 100, a GP lens unit 110C, the variable phase difference element unit 120C, and the polarizer 130. The GP lens unit 110C, the variable phase difference element unit 120C, and the polarizer 130 are provided above the light source 100 in this order. That is, the GP lens unit 110C is provided directly above the light source 100.

The GP lens unit 110C shown in FIGS. 4A and 4B includes a plurality of GP lenses 110. That is, the GP lens unit 110C includes a first GP lens 110-1, a second GP lens 110-2, and a third GP lens 110-3. Further, the variable phase difference element unit 120C includes a plurality of variable phase difference elements 120. That is, the variable phase difference element unit 120C includes a first variable phase difference element 120-1, a second variable phase difference element 120-2, and a third variable phase difference element 120-3.

In FIG. 4A, the variable phase difference elements 120 included in the variable phase difference element unit 120C have a phase difference of ¼ wavelength, and the polarizer 130 can transmit linearly polarized light of θ=+45°

The light 800 emitted from the light source 100 is incident on the GP lenses 110 of the GP lens unit 110C. The incident light is separated into the right-handed circularly polarized light 811 and the left-handed circularly polarized light 812 by the GP lenses 110. Further, the right-handed circularly polarized light 811 is focused to a focal length +f by the GP lens 110. On the other hand, the left-handed circularly polarized light 812 is focused to a focal length −f (not shown) by the GP lens 110, but the left-handed circularly polarized light 812 is diffused on the variable phase difference element unit 120C side. As shown in FIG. 4A, the first GP lens 110-1, the second GP lens 110-2, and the third GP lens 110-3 have their respective focal positions. That is, when there are three GP lenses 110, three focal positions appear.

When the right-handed circularly polarized light 811 and the left-handed circularly polarized light 812 are incident on the variable phase difference elements 120 included in the variable phase difference element unit 120C, the right-handed circularly polarized light 811 and the left-handed circularly polarized light 812 are converted into the linearly polarized light 821 of θ=+45° and the linearly polarized light 822 of θ=−45°, respectively, by the variable phase difference elements 120. Since the linearly polarized light 821 of θ=+45° can transmit through the polarizer 130, the light 831 transmitted through the polarizer 130 is emitted to the outside of the polarizer 130. On the other hand, the linearly polarized light 822 of θ=−45° cannot transmit through the polarizer 130. Therefore, the light 831 from the lighting device 10C is light based on the right-handed circularly polarized light 811 and is focused to the vicinity of the focal length +f in the respective focal positions and emitted to the outside.

Next, as shown in FIG. 4B, the second variable phase difference element 120-2 is controlled so as to have a phase difference of ¾ wavelength. When the right-handed circularly polarized light 811 and the left-handed circularly polarized light 812 are incident on the second variable phase difference element 120-2, the right-handed circularly polarized light 811 and the left-handed circularly polarized light 812 are converted into the linearly polarized light 821 of θ=−45° and the linearly polarized light 822 of θ=+45°, respectively, by the second variable phase difference element 120-2. Since the linearly polarized light 821 of θ=+45° can transmit through the polarizer 130, light 831 transmitted through the polarizer 130 is emitted to the outside of the polarizer 130. On the other hand, the linearly polarized light 822 of θ=−45° cannot transmit through the polarizer 130. Therefore, the light 831 from the lighting device 10C is light based on not only the right-handed circularly polarized light that are transmitted through the first variable phase difference element 120-1 and the third variable phase difference element 120-3 but also the left-handed circularly polarized light 812 that is transmitted through the second variable phase difference element 120-2, and emitted to the outside. In the lighting device 10C, each of the first GP lens 110-1, the second GP lens 110-2, and the third GP lens 110-3 has a focal position. Therefore, the focused light 831 is emitted for the focal positions of the first GP lens 110-1 and the third GP lens 110-3, and the diffused light 831 is emitted for the focal position of the second GP lens 110-2.

As described above, the lighting device 10C can switch between the focused emitted light and the diffused emitted light for each focal position of the GP lens 110 included in the GP lens unit 110C by controlling the variable phase difference elements 120 included in the variable phase difference element unit 120C. For example, the lighting device 10C can control the emitted light in a region smaller than the size of the light source 100.

### Modification Example 4

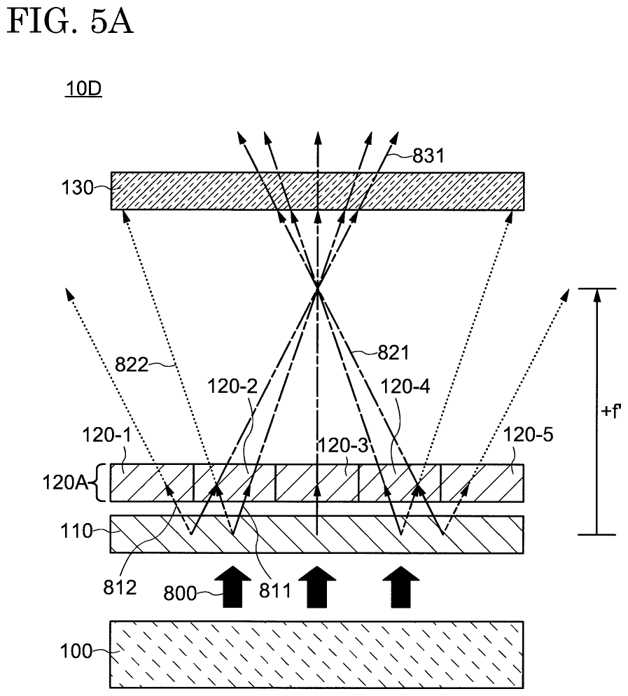

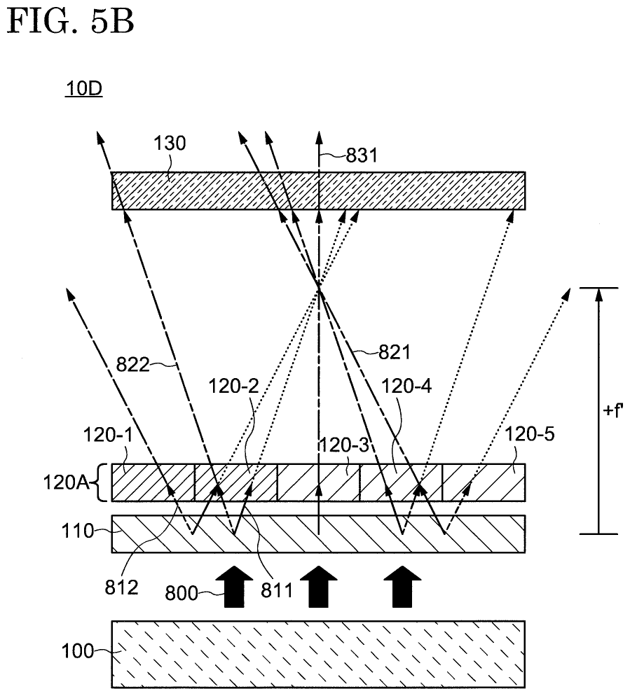

Referring to FIGS. 5A and 5B, a lighting device 10D according to an embodiment of the present invention is described.

FIGS. 5A and 5B are schematic cross-sectional views of the lighting device 10D according to the embodiment of the present invention, respectively. As shown in FIGS. 5A and 5B, the lighting device 10D includes the light source 100, the GP lens 110, a variable phase difference element unit 120A, and the polarizer 130. The GP lens 110, the variable phase difference element unit 120A, and the polarizer 130 are provided above the light source 100 in this order. That is, the GP lens 110 is provided directly above the light source 100.

The lighting device 10D shown in FIGS. 5A and 5B has a different focal length of the GP lens 110 from the lighting device 10A shown in FIGS. 2A to 2C. The GP lens 110 of the lighting device 10D has a focal length +f at a position away from the polarizer 130. That is, the GP lens 110 of the lighting device 10D has the focal length +f′ between the variable phase difference element 120 and the polarizer 130.

In FIG. 5A, the variable phase difference elements 120 included in the variable phase difference element unit 120A have a phase difference of ¼ wavelength, and the polarizer 130 can transmit linearly polarized light of θ=+45°

The light 800 emitted from the light source 100 is incident on the GP lens 110. The incident light is separated into the right-handed circularly polarized light 811 and the left-handed circularly polarized light 812 by the GP lens 110. Further, the right-handed circularly polarized light 811 is focused to a focal length +f′ by the GP lens 110. On the other hand, the left-handed circularly polarized light 812 is focused to a focal length −f′ (not shown) by the GP lens 110, but the left-handed circularly polarized light 812 is diffused on the variable phase difference element unit 120A side. When the right-handed circularly polarized light 811 and the left-handed circularly polarized light 812 are incident on the variable phase difference elements 120 included in the variable phase difference element unit 120A, the right-handed circularly polarized light 811 and the left-handed circularly polarized light 812 are converted into the linearly polarized light 821 of θ=+45° and the linearly polarized light 822 of θ=−45°, respectively, by the variable phase difference elements 120. Since the linearly polarized light 821 of θ=+45° can transmit through the polarizer 130, the light 831 transmitted through the polarizer 130 is emitted to the outside of the polarizer 130. On the other hand, the linearly polarized light 822 of θ=−45° cannot transmit through the polarizer 130. Therefore, the light 831 from the lighting device 10D is light based on the right-handed circularly polarized light 811 and is focused in the vicinity of the focal length +f′, but the focal position is away from the polarizer 130. Therefore, the light 831 from the lighting device 10D is light having a slightly wider spread than the light 831 from the lighting device 10A.

Next, as shown in FIG. 5B, the first variable phase difference element 120-1 and the second variable phase difference element 120-2 are controlled so as to have a phase difference of ¾ wavelength. When the right-handed circularly polarized light 811 and the left-handed circularly polarized light 812 are incident on the first variable phase difference element 120-1 and the second variable phase difference element 120-2, the right-handed circularly polarized light 811 and the left-handed circularly polarized light 812 are converted into the linearly polarized light 821 of θ=−45° and the linearly polarized light 822 of 8=+45°, respectively, by the first variable phase difference element 120-1 and the second variable phase difference element 120-2. Since the linearly polarized light 821 of θ=+45° can transmit through the polarizer 130, the light 831 transmitted through the polarizer 130 is emitted to the outside of the polarizer 130. On the other hand, the linearly polarized light 822 of θ=−45° cannot transmit through the polarizer 130. Therefore, the light 831 from the lighting device 10D is light based on not only the right-handed circularly polarized light that is transmitted through the third variable phase difference element 120-3, the fourth variable phase difference element 120-4, and the fifth variable phase difference element 120-5 but also the left-handed circularly polarized light 812 that is transmitted through the first variable phase difference element 120-1 and the second variable phase difference element 120-2, and emitted to the outside.

As described above, the lighting device 10D can switch the focused emitted light and the diffused emitted light while controlling the emission position of the light by controlling the variable phase difference elements 120 included in the variable phase difference element unit 120A. Further, the lighting device 10D can adjust the spread of the focused emitted light.

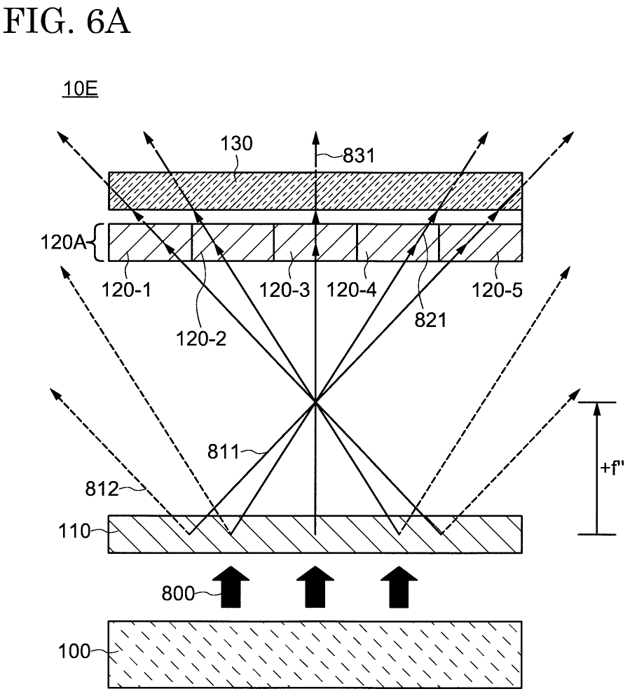

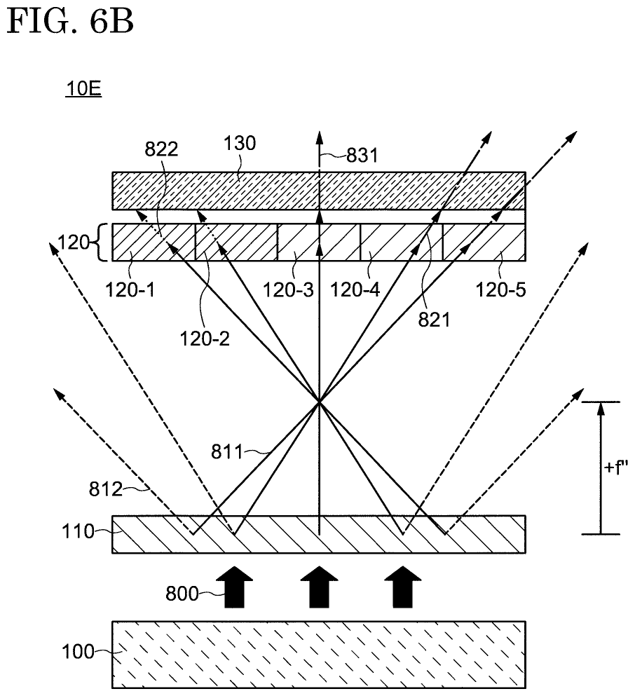

Referring to FIGS. 6A and 6B, a lighting device 10E according to an embodiment of the present invention is described.

FIGS. 6A and 6B are schematic cross-sectional views of the lighting device 10E according to the embodiment of the present invention, respectively. As shown in FIGS. 6A and 6B, the lighting device 10E includes the light source 100, the GP lens 110, the variable phase difference element unit 120A, and the polarizer 130. The GP lens 110, the variable phase difference element unit 120A, and the polarizer 130 are provided above the light source 100 in this order. That is, the GP lens 110 is provided directly above the light source 100.

The lighting device 10E shown in FIGS. 6A and 6B has a different focal length of the GP lens 110 from the lighting device 10A shown in FIGS. 2A to 2C. In the lighting device 10E, the variable phase difference element unit 120A is arranged at a position closer to the polarizer 130 than that of the lighting device 10A. Further, the lighting device 10E is different from the lighting device 10A in the focal position and the focal length of the GP lens. The GP lens 110 of the lighting device 10E has the focal length +f″ between the GP lens and the variable phase difference element unit 120A.

In FIG. 6A, the variable phase difference elements 120 included in the variable phase difference element unit 120A have a phase difference of ¼ wavelength, and the polarizer 130 can transmit linearly polarized light of θ=+45°

The light 800 emitted from the light source 100 is incident on the GP lens 110. The incident light is separated into the right-handed circularly polarized light 811 and the left-handed circularly polarized light 812 by the GP lens 110. Further, the right-handed circularly polarized light 811 is focused to a focal length +f″ by the GP lens 110. On the other hand, the left-handed circularly polarized light 812 is focused to a focal length −f″ (not shown) by the GP lens 110, but the left-handed circularly polarized light 812 is diffused on the variable phase difference element unit 120A side. When the right-handed circularly polarized light 811 and the left-handed circularly polarized light 812 are incident on the variable phase difference elements 120 included in the variable phase difference element unit 120A, the right-handed circularly polarized light 811 and the left-handed circularly polarized light 812 are converted into the linearly polarized light 821 of θ=+45° and the linearly polarized light 822 of θ=−45°, respectively, by the variable phase difference elements 120. Since the linearly polarized light 821 of θ=+45 can transmit through the polarizer 130, the light 831 transmitted through the polarizer 130 is emitted to the outside of the polarizer 130. On the other hand, the linearly polarized light 822 of θ=−45 cannot transmit through the polarizer 130. Therefore, the light 831 from the lighting device 10E is light based on the right-handed circularly polarized light 811 and is focused in the vicinity of the focal length +f″, but the focal position is far from the polarizer 130. Therefore, the light 831 from the lighting device 10E is light having a larger spread than the light 831 from the lighting device 10A.

Next, as shown in FIG. 6B, the first variable phase difference element 120-1 and the second variable phase difference element 120-2 are controlled so as to have a phase difference of ¾ wavelength. When the right-handed circularly polarized light 811 and the left-handed circularly polarized light 812 are incident on the first variable phase difference element 120-1 and the second variable phase difference element 120-2, the right-handed circularly polarized light 811 and the left-handed circularly polarized light 812 are converted into the linearly polarized light 821 of θ=−45° and the linearly polarized light 822 of 8=+45°, respectively, by the first variable phase difference element 120-1 and the second variable phase difference element 120-2. Since the linearly polarized light 821 of θ=+45° can transmit through the polarizer 130, the light 831 transmitted through the polarizer 130 is emitted to the outside of the polarizer 130. On the other hand, the linearly polarized light 822 of θ=−45° cannot transmit through the polarizer 130. Therefore, the light 831 from the lighting device 10E is light based on not only the right-handed circularly polarized light that is transmitted through the third variable phase difference element 120-3, the fourth variable phase difference element 120-4, and the fifth variable phase difference element 120-5 but also the left-handed circularly polarized light 812 that is transmitted through the first variable phase difference element 120-1 and the second variable phase difference element 120-2, and emitted to the outside.

As described above, the lighting device 10E can switch the focused emitted light and the diffused emitted light while controlling the emission position of the light by controlling the variable phase difference elements 120 included in the variable phase difference element unit 120A. Further, the lighting device 10E can adjust the spread of the focused emitted light.

As can be seen from <Modification Example 4> and <Modification Example 5>, the spread of the emitted light that is focused by the GP lens 110 can be controlled by adjusting the position of the variable phase difference element unit 120A and the focal length of the GP lens 110. In order to control the emitted light that is focused by the GP lens 110, it is preferable that the variable phase difference element unit 120A or the variable phase difference element 120 is arranged in the vicinity of the GP lens 110 or in the vicinity of the polarizer 130.

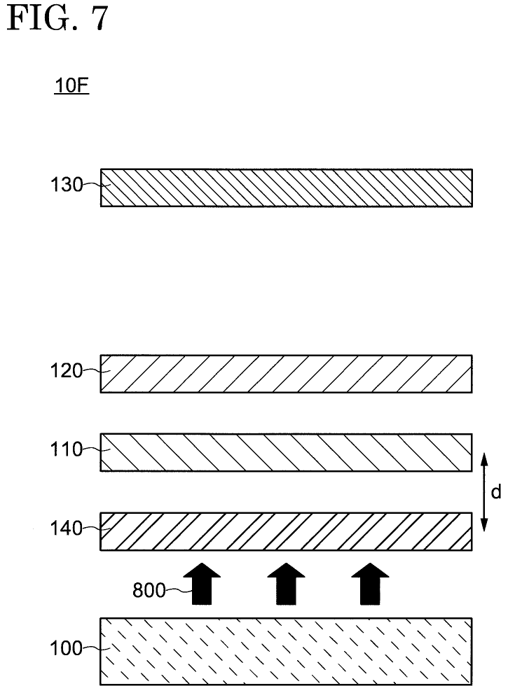

Referring to FIG. 7, a lighting device 10F according to an embodiment of the present invention is described.

FIG. 7 is a schematic cross-sectional view of the lighting device 10F according to the embodiment of the present invention. As shown in FIG. 7, the lighting device 10F includes the light source 100, a lens 140, the GP lens 110, the variable phase difference element 120, and the polarizer 130. The lens 140, the GP lens 110, the variable phase difference element 120, and the polarizer 130 are provided above the light source 100 in this order. That is, the lens 140 is provided directly above the light source 100.

The lens 140 has a function of adjusting the focal length of the GP lens 110. As the lens 140, for example, a convex lens can be used.

In FIG. 7, the lens 140 has a focal length +f₁ and the GP lens 110 has a focal length ±f₂. Further, the lens 140 and the GP lens 110 are arranged so as to have a distance d. In this case, the adjusted focal length f of the GP lens 110 is expressed by the following equation 1.

$$f = \frac{\pm {f}_{1} {f}_{2}}{{f}_{1} \pm {f}_{2} - d} \qquad \text{<} equation 1 \text{>}$$

As can be seen from the equation 1, the focal length of the GP lens 110 can be adjusted to have two positive values or two negative values from ±f₂ by arranging the lens 140. Therefore, in the lighting device 10F, the spread of the emitted light can be controlled by using the lens 140.

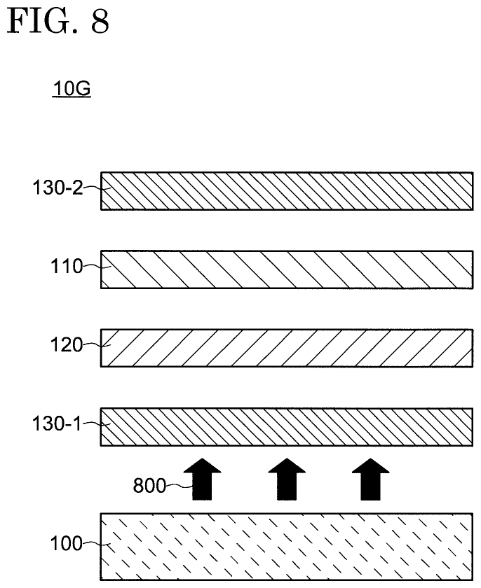

Referring to FIG. 8, a lighting device 10G according to an embodiment of the present invention is described.

FIG. 8 is a schematic cross-sectional view of the lighting device 10G according to the embodiment of the present invention. As shown in FIG. 8, the lighting device 10G includes the light source 100, a first polarizer 130-1, the variable phase difference element 120, the GP lens 110, and a second polarizer 130. The first polarizer 130-1, the variable phase difference element 120, the GP lens 110, and the second polarizer 130-2 are provided above the light source 100 in this order. That is, the first polarizer 130-1 is provided directly above the light source 100.

In the lighting device 10G, the light 800 emitted from the light source 100 is converted into the linearly polarized light by the first polarizer 130-1. Further, in the lighting device 10G, the polarization state of light can be controlled by the variable phase difference element 120. That is, the first polarizer 130-1 of the lighting device 10G has a function of converting the light into light so that the polarization state can be controlled by the variable phase difference element 120. Therefore, the first polarizer 130-1 may be capable of converting not only linearly polarized light but also circularly polarized light. As the first polarizer 130-1, for example, a linear polarizing plate or a circular polarizing plate can be used. Further, a reflective polarizing film (DBEF) may be used as the first polarizer 130-1. By using DEEF, the brightness of the light incident on the variable phase difference element 120 can be improved.

The light whose polarization state is controlled by the variable phase difference element 120 is separated by the GP lens 110 into, for example, the focused right-handed circularly polarized light and the diffused left-handed circularly polarized light. When the second polarizer 130-2 transmits only the right-handed circularly polarized light, the lighting device 10G emits the focused light.

On the other hand, when the polarization state of the light is switched by the variable phase difference element 120, the light can be separated into the diffused right-handed circularly polarized light and the focused left-handed circularly polarized light by the GP lens 120. When the second polarizer 130-2 transmits only the right-handed circularly polarized light, the lighting device 10G emits the diffused light.

Therefore, the lighting device 10G can also switch between the focused emitted light and the diffused emitted light by controlling the variable phase difference element 120.

As described above, the lighting device 10 according to the present embodiment, including the modification example, can control the position, the spread, the light amount, and the like of the light emitted from the lighting device 10 by using the GP lens 110 and the variable phase difference element 120.

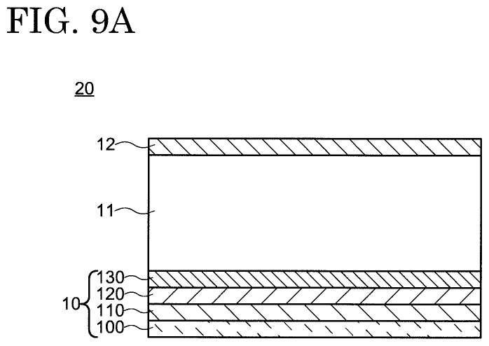

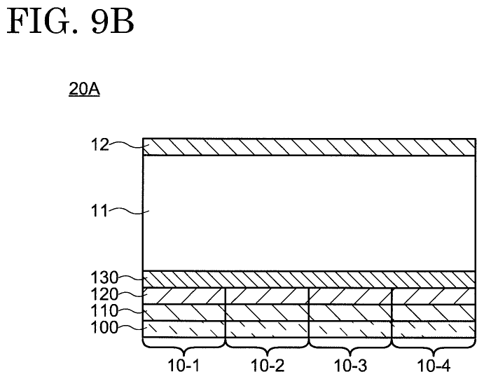

Referring to FIGS. 9A to 13, a display device 20 according to an embodiment of the present invention is described.

FIG. 9A is a schematic cross-sectional view of the display device 20 according to the embodiment of the present invention. As shown in FIG. 9A, the display device 20 includes the lighting device 10, a liquid crystal cell 11 (also referred to as a display panel), and a polarizer 12. The lighting device 10 includes the light source 100, the GP lens 110, the variable phase difference element 120, and the polarizer 130. The liquid crystal cell 11 is provided between the lighting device 10 and the polarizer 12. Further, the polarizer 130 of the lighting device 10 is provided on one surface of the liquid crystal cell 11, and a polarizer 12 is provided on the other surface of the liquid crystal cell 11.

The details of the liquid crystal cell 11 is described later.

Each of the polarizers 130 and 12 is, for example, a linear polarizing plate. It is preferable that the linear polarizing plate of the polarizer 130 and the linear polarizing plate of the polarizer 12 are arranged so as to form a cross Nicol in which the transmission axes intersect with each other.

In the display device 20, the lighting device 10 can function as a so-called backlight. By controlling the variable phase difference element 120, the lighting device 10 can not only partially emit the focused light but also emit a wide range with the diffused light. Therefore, in the display device 20, the lighting device 10 can function as a backlight that emits a plurality of different lights by using one light source. In the display device 20, the configuration of the lighting device 10 excluding the polarizer 130 may be referred to as a backlight.

Referring to FIG. 9B, a display device 20A that can perform local dimming drive is described.

FIG. 9B is a schematic plan view of the display device 20A according to the embodiment of the present invention. As shown in FIG. 9B, the display device 20A includes a first lighting device 10-1, a second lighting device 10-2, a third lighting device 10-3, a fourth lighting device 10-4, the liquid crystal cell 11, and the polarizer 12. Each of the first lighting device 10-1, the second lighting device 10-2, the third lighting device 10-3, and the fourth lighting device 10-4 has the light source 100, the GP lens 110, the variable phase difference element 120, and the polarizer 130. The polarizer 130 is commonly provided in the first lighting device 10-1, the second lighting device 10-2, the third lighting device 10-3, and the fourth lighting device 10-4. The liquid crystal cell 11 is provided between the lighting device 10 and the polarizer 12. Further, the polarizer 130 of the lighting device 10 is provided on one surface of the liquid crystal cell 11, and a polarizer 12 is provided on the other surface of the liquid crystal cell 11.

The display device 20A is divided into a plurality of lighting devices 10 in order to perform local dimming drive. Each of the plurality of lighting devices 10 can be independently perform local dimming drive. Further, the plurality of lighting devices 10 independently control the variable phase difference element 120 provided therein. That is, the light that is transmitted through each of the plurality of lighting devices 10 and is incident on the liquid crystal cell 11 can have different directions of focus and diffusion. In other words, the directions in which the light transmitting through each of the plurality of lighting devices 10 is incident on the liquid crystal cell 11 can be made different. Therefore, the display device 20A can not only partially emit brightly, but also emit a wide range with the diffused light. That is, in the display device 20A, when the local dimming drive is performed, the halo phenomenon can be suppressed by adjusting the spread of the focused light by the lighting device 10.

Hereinafter, the configuration of the display device 20 is described, but the configuration of the display device 20A can also be applied in the same manner.

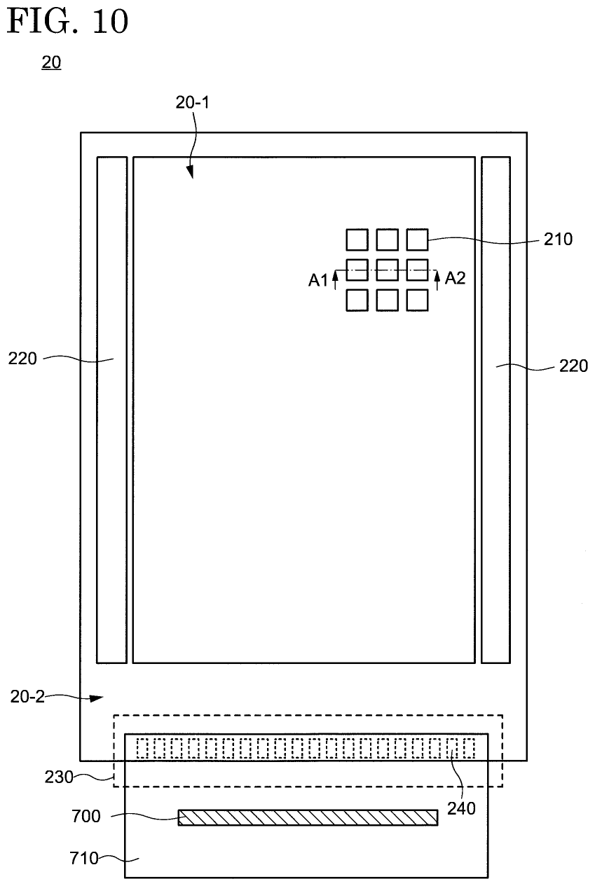

FIG. 10 is a schematic plan view of the display device 20 according to an embodiment of the present invention.

As shown in FIG. 10, the display device 20 includes a display area 20-1 and a peripheral area 20-2. The peripheral area 20-2 is located outside the display area 20-1.

Although a boundary between the display area 20-1 and the peripheral area 20-2 is not always clear, the display area 20-1 is an area where an image or a moving image can be displayed. The shape of the display area 20-1 shown in FIG. 10 is a rectangle having a long side and a short side, but the shape of the display area 20-1 is not limited to this. The shape of the display area 20-1 can be any shape that matches the size or shape of the display device 20, such as a polygon, a circle, or an ellipse.

The display area 20-1 includes a plurality of pixels 210. The plurality of pixels 210 shown in FIG. 10 are arranged in a matrix. However, the arrangement of the plurality of pixels 210 is not limited to this. The plurality of pixels 210 may be arranged in a staggered pattern, for example.

The peripheral area 20-2 includes a scanning line drive circuit portion 220 and a terminal portion 230. The scanning line drive circuit portion 220 shown in FIG. 10 is provided along the long side direction of the rectangle of the display area 20-1. However, the position of the scanning line drive circuit portion 220 is not limited to this. The scanning line drive circuit portion 220 may be provided, for example, along the short side direction of the rectangle of the display area 20-1.

The scanning line drive circuit portion 220 shown in FIG. 10 is provided at two locations on the long side of the rectangle in the display area 20-1, but may be provided at one location on the long side of the rectangle. Further, the scanning line drive circuit portion 220 may be provided on the short side of the rectangle of the display area 20-1.

A power or a signal can be supplied from the outside to the display device 20 by using the terminal portion 230. Therefore, the terminal portion 230 includes a plurality of terminals 240 that can be electrically connected to devices of the outside. The plurality of terminals 240 shown in FIG. 10 are electrically connected to the flexible printed circuits (FPCs) 710. Further, a driver IC 700 is provided on the flexible printed circuits 710.

The terminal portion 230 is provided at an end of the display device 20. A video signal and a control signal are supplied to the display device 20 from a controller (not shown) provided outside the display device 20 via the flexible printed circuits 710. Further, the video signal and the control signal are converted into signals for the display device 20 via the driver IC 700, and are input to the plurality of pixels 210 and the scanning line drive circuit unit 220, respectively. Further, not only the video signal and the control signal, but also power for driving the scanning line drive circuit unit 220, the driver IC 700, and the plurality of pixels 210 is supplied to the display device 20.

Here, the liquid crystal cell 11 is described.

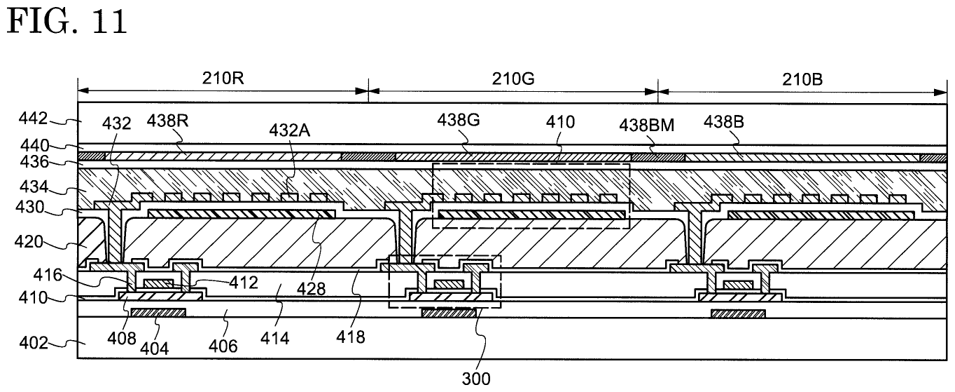

FIG. 11 is a cross-sectional view of a display area 20-1 of the display device 20 according to the embodiment of the present invention. Specifically, FIG. 11 is a cross-sectional view of the liquid crystal cell 11 in the display region 20-1 cut along the lines A1-A2 shown in FIG. 10.

As shown in FIG. 11, the display device 20 includes a first substrate 402, a light-shielding layer 404, a first insulating layer 406, a semiconductor layer 408, a second insulating layer 410, a first conductive layer 412, a third insulating layer 414, a second conductive layer 416, a fourth insulating layer 418, an organic resin layer 420, a first electrode layer 428, a fifth insulating layer 430, a second electrode layer 432, a liquid crystal layer 434, a sixth insulating layer 436, a light shielding film 438BM, a red color filter film 438R, a green color filter film 438G, a blue color filter film 438B, a seventh insulating layer 440, and a second substrate 442.

In FIG. 11, as the plurality of pixels 210, a red pixel 210R, a green pixel 210G, and a blue pixel 210B are shown. Each of the red pixel 210R, the green pixel 210G, and the blue pixel 210B includes a transistor 300 that controls the pixel 210.

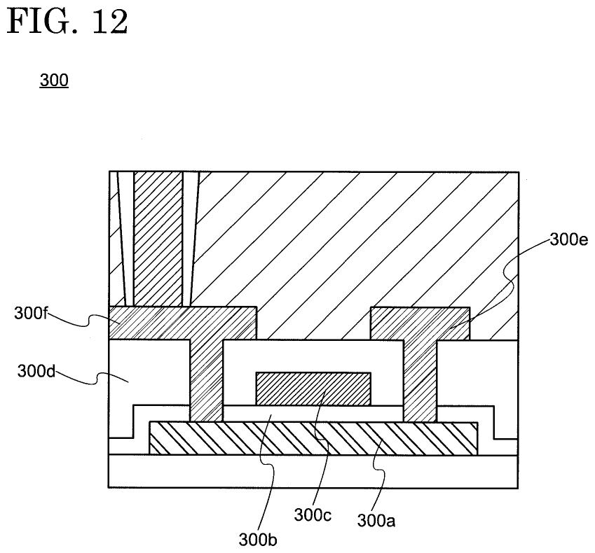

Referring to FIG. 12, the transistor 300 is described.

FIG. 12 is a schematic cross-sectional view of the transistor 300 included in the display device 20 according to the embodiment of the present invention. As shown in FIG. 12, the transistor 300 includes a semiconductor layer 300a, a gate insulating layer 300b, a gate electrode 300c, an interlayer insulating layer 300d, a source electrode 300e, and a drain electrode 300f. The gate insulating layer 300b is provided so as to cover the semiconductor layer 300a. The interlayer insulating layer 300d is provided so as to cover the gate electrode 300c. An opening portion is provided in the gate insulating layer 300b and the interlayer insulating layer 300d, and the source electrode 300e and the drain electrode 300f are electrically connected to the semiconductor layer 300a through the opening portion.

The transistor 300 shown in FIG. 12 is a top gate type transistor. In this case, the semiconductor layer 300a, the gate insulating layer 300b, the gate electrode 300c, the interlayer insulating layer 300d, and the source electrode 300e and the drain electrode 300f can be formed of the semiconductor layer 408, the second insulating layer 410, the first conductive layer 412, a third insulating layer 414, and the second conductive layer 416, respectively. The transistor 300 included in the display device 20 is not limited to the top gate type transistor. As the transistor 300, a bottom gate type transistor and a dual gate type transistor in which a semiconductor layer is sandwiched between upper and lower gate electrodes can also be used.

As a material of the semiconductor layer 300a, for example, an amorphous silicon, a polysilicon, an oxide semiconductor such as IGZO, or a compound semiconductor such as gallium nitride can be used. The semiconductor layer 300a can include not only a channel formation region but also a source region or a drain region (a high-concentration impurity region). It is also possible to include a low concentration impurity region between the channel formation region and the source region or drain region.

As a material of the gate insulating layer 300b, for example, silicon oxide, silicon nitride, aluminum oxide, or aluminum nitride can be used. Further, the gate insulating layer 300b can be a single layer or a laminated layer.

As a material of the gate electrode 300c, for example, a metal such as aluminum (Al), titanium (Ti), molybdenum (Mo), copper (Cu), or tungsten (W), or an alloy thereof can be used. Further, the gate electrode 300c can be a single layer or a laminated layer.

As a material of the interlayer insulating layer 300d, for example, silicon oxide, silicon nitride, aluminum oxide, or aluminum nitride can be used. Further, the interlayer insulating layer 300d can be a single layer or a laminated layer.

As a material of the source electrode 300e and the drain electrode 300f, for example, a metal such as aluminum (Al), titanium (Ti), molybdenum (Mo), copper (Cu), or tungsten (W), or an alloy thereof can be used. Further, the source electrode 300e and the drain electrode 300f can be a single layer or a laminated layer. The opening portion portions are provided in the gate insulating layer 300b and the interlayer insulating layer 300d. The source electrode 300e and the drain electrode 300f are electrically connected to the semiconductor layer 300a through the opening portions provided in the gate insulating layer 300b and the interlayer insulating layer 300d.

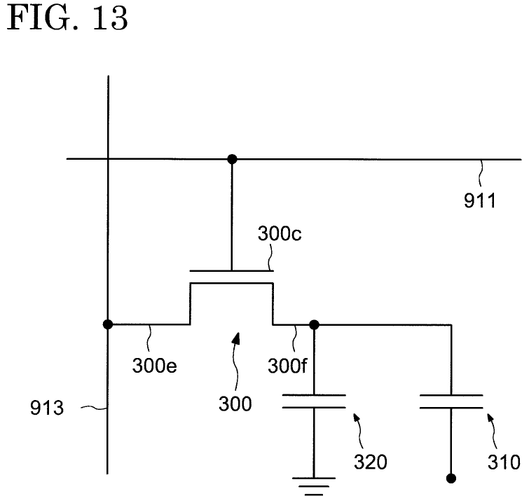

Further, referring to FIG. 13, a control of the pixel 210 of the display device 20 is described.

FIG. 13 is a circuit diagram of a pixel circuit in the pixel 210 of the display device 20 according to the embodiment of the present invention. Each of the plurality of pixels 210 has a pixel circuit shown in FIG. 13. The pixel circuit includes a transistor 300, a gate wiring (scanning line) 911, a source wiring (signal line) 913, a liquid crystal element 310, and a capacitance element 320. The gate electrode 300c of the transistor 300 is electrically connected to the gate wiring 911. The source electrode 300e is electrically connected to the source wiring 913. The drain electrode 300f is electrically connected to the liquid crystal element 310 and the capacitance element 320. In the present embodiment, for convenience of explanation, 300e is referred to as a source electrode and 300f is referred to as a drain electrode, but the function as a source and the function as a drain of each electrode may be interchanged.

In the transistor 300, a conduction state between the source electrode 300e and the drain electrode 300f is controlled by a signal of the gate wiring 911. Therefore, an on/off of the liquid crystal element 310 of each pixel 210 can be controlled by the transistor 300 provided in each pixel 210. The transistor 300 may be an n-channel transistor or a p-channel transistor.

The capacitance element 320 is provided in parallel with the liquid crystal element 310 and can hold a voltage of the liquid crystal element 310. In FIG. 11, the capacitance element 320 is a capacitance formed between the first electrode layer 428 (common electrode) and the second electrode layer 432 (pixel electrode). Although not shown, the capacitance element 320 can be formed so that the gate insulating layer 300b is sandwiched between a conductive layer formed in the same process as the source region or drain region of the semiconductor layer 300a and a conductive layer formed in the same process as the gate electrode 300c. Further, the capacitance element 320 can be formed so that the interlayer insulating layer 300d is sandwiched between a conductive layer formed in the same process as the gate electrode 300c and a conductive layer formed in the same process as the source electrode 300e or the drain electrode 300f.

Returning to FIG. 11, the liquid crystal cell 11 of the display device 20 is described.

The first substrate 402 can function as a support substrate that supports each layer formed on the first substrate 402. As the first substrate 402, for example, a rigid substrate such as a glass substrate, a quartz substrate, and a sapphire substrate can be used. Further, as the first substrate 402, for example, a flexible substrate such as a polyimide substrate, an acrylic substrate, a siloxane substrate, or a fluororesin substrate can be used. Impurities may be introduced into the flexible substrate in order to improve the heat resistance of the flexible substrate.

The light-shielding layer 404 can shield the channel formation region of the semiconductor layer 408 from light-shielding. Therefore, it is preferable that the light-shielding layer 404 is overlapped with the semiconductor layer 300a of the transistor 300. As a material of the light-shielding layer 404, for example, a metal such as aluminum (Al), titanium (Ti), molybdenum (Mo), copper (Cu), or tungsten (W), or an alloy thereof can be used. Further, the light-shielding layer 404 can be a single layer or a laminated layer.

The first insulating layer 406 can function as an interlayer insulating layer that electrically separates the light-shielding layer 404 and the semiconductor layer 408. As a material of the first insulating layer 406, for example, silicon oxide, silicon nitride, aluminum oxide, aluminum nitride, or the like can be used. Further, the first insulating layer 406 may be a single layer or a laminated layer. The semiconductor layer 408, the second insulating layer 410, the first conductive layer 412, the third insulating layer 414, and the second conductive layer 416 can be formed as the layers of the transistor 300 as described above. Further, the first conductive layer 412 and the second conductive layer 416 can also be formed as a part of the gate wiring 911 and the source wiring 913. Further, the second insulating layer 410 or the third insulating layer 414 can be formed as a dielectric material of the capacitance element 320. The materials of the semiconductor layer 408, the second insulating layer 410, the first conductive layer 412, the third insulating layer 414, and the second conductive layer 416 can be used as the same materials as the semiconductor layer 300a, the gate insulating layer 300b, the gate electrode 300c, the interlayer insulating layer 300d and the source electrode 300e and the drain electrode 300f, respectively.

The fourth insulating layer 418 can function as a protective layer for the transistor 300. As a material of the fourth insulating layer 418, for example, silicon oxide, silicon nitride, aluminum oxide, aluminum nitride, or the like can be used. Further, the fourth insulating layer 418 can be a single layer or a laminated layer.

The organic resin layer 420 can function as a flattening layer. That is, the organic resin layer 420 can cover the transistor 300 and flatten steps of the transistor 300. As a material of the organic resin layer 420, for example, a photosensitive organic material such as photosensitive acrylic or photosensitive polyimide can be used.

The first electrode layer 428 can function as a common electrode for driving the liquid crystals of the liquid crystal element 310. As a material of the first electrode layer 428, for example, a transparent conductive oxide such as indium tin oxide (ITO) or indium zinc oxide (IZO) can be used.

The fifth insulating layer 430 can function as an interlayer insulating layer that electrically insulates the first electrode layer 428 and the second electrode layer 432. Further, the fifth insulating layer 430 can function as a protective layer of the organic resin layer 420. Further, the fifth insulating layer 430 can function as a capacitive insulating film for forming the capacitive element 320 between the first electrode layer 428 and the second electrode layer 432.

The second electrode layer 432 can function as a pixel electrode for driving the liquid crystals of the liquid crystal element 310. As a material of the second electrode layer 432, a transparent conductive oxide such as indium tin oxide (ITO) or indium zinc oxide (IZO) can be used. The second electrode layer 432 is formed in a comb-teeth shape 432A in the region overlapping the first electrode layer 428.

An opening portion is provided in the organic resin layer 420 and the fifth insulating layer 430. In FIG. 11, the fifth insulating layer 430 is provided on the side surface of the opening portion. It is preferable that the fifth insulating layer 430 covers the side surface of the opening portion, but the fifth insulating layer 430 may not be provided on the side surface of the opening portion. The second electrode layer 432 is electrically connected to the second conductive layer 416 through the opening portion provided in the organic resin layer 420 and the fifth insulating layer 430.

The liquid crystal layer 434 includes liquid crystals. As a material of the liquid crystal, an organic polymer material having an alignment such as a nematic phase, a smectic phase, a cholesteric phase, or a discotic phase can be used. Further, an alignment film for aligning the liquid crystal molecules may be arranged above and below the liquid crystal layer 434. The alignment film is formed on the second electrode layer 432. As a material of the alignment film, for example, polyimide or the like can be used.

The liquid crystal element 310 shown in FIG. 11 is driven by a so-called transverse electric field drive method in which a voltage is applied to the liquid crystal layer 434 by using the first electrode layer 428 and the second electrode layer 432. In FIG. 11, the first electrode layer 428 and the second electrode layer 432 are formed in different layers with the fifth insulating layer 430 interposed therebetween, but the first electrode layer 428 and the second electrode layer 432 can be formed in the same layer. Even in this case, the liquid crystal element 310 is driven by a transverse electric field drive method. Further, the liquid crystal element 310 may be configured such that the liquid crystal layer 434 is sandwiched between the first electrode layer 428 and the second electrode layer 432. In this case, the liquid crystal element 310 is driven by a vertical electric field drive method. In the display device 20, either the transverse electric field drive method or the vertical electric field drive method can be applied to drive the liquid crystal element 310.

The sixth insulating layer 436 can function as a protective film that protects the light-shielding film 438BM, the red color filter film 438R, the green color filter film 438G, and the blue color filter film 438B. As a material of the sixth insulating layer 436, for example, silicon oxide, silicon nitride, aluminum oxide, aluminum nitride, photosensitive acrylic, or the like can be used. Further, the sixth insulating layer 436 can be a single layer or a laminated layer.

The light-shielding film 438BM is, for example, a black matrix. The light-shielding film 438BM can separate the pixels 210 and make the region between the pixels 210 non-transmissive. That is, the red pixel 210R, the green pixel 210G, and the blue pixel 210B are separated by the light-shielding film 438BM. As a material of the light-shielding film 438BM, for example, an organic material containing light-shielding fine particles such as carbon, a metal oxide, an inorganic pigment, or an organic pigment can be used.

The red color filter film 438R, the green color filter film 438G, and the blue color filter film 438B are provided in the red pixel 210R, the green pixel 210G, and the blue pixel 210B, respectively. Further, the green color filter film 438G and the blue color filter film 438B are separated by the light-shielding film 438BM, but even if the green color filter film 438G or the blue color filter film 438B may be overlapped with the light-shielding film 438BM. As materials for the red color filter film 438R, the green color filter film 438G, and the blue color filter film 438B, a red color resist, a green color resist, and a blue color resist can be used, respectively.

The seventh insulating layer 440 can function as a protective film that protects the color resist from deteriorating. As a material of the seventh insulating layer 440, for example, silicon oxide, silicon nitride, aluminum oxide, aluminum nitride, or the like can be used. Further, the seventh insulating layer 440 can be a single layer or a laminated layer.

The second substrate 442 can support layers formed over the second substrate 442. Further, as a material of the second substrate 442, the same material as that of the first substrate 402 can be used.

As described above, the display device 20 and the display device 20A according to the present embodiment can control the position, the spread, the amount of light, and the like of the light emitted from the lighting device 10. Therefore, the display device 20 and the display device 20A can control the light of the backlight and improve the display quality. Further, in the case of local dimming drive, the halo phenomenon can be suppressed by adjusting the spread of the converged light by the lighting device 10.

Each embodiment described above as embodiments of the present invention can be implemented in combination as appropriate as long as they do not contradict each other. In addition, those skilled in the art could appropriately add, delete or change the design of the constituent elements based on the display device of each embodiment, or add, omit or change conditions as long as it does not depart from the concept of the present invention and such changes are included within the scope of the present invention.

Even if other actions and effects different from the actions and effects brought about by the aspects of each embodiment described above are obvious from the description of the present specification or those which could be easily predicted by those skilled in the art, such actions and effects are to be interpreted as being provided by the present invention.

What is claimed is:

1. A lighting device comprising:
a light source;
a geometric phase lens over the light source, the geometric phase lens configured to separate an incident light into a first light having a focal length +f and a second light having a focal length −f; and
a variable phase difference element over the geometric phase lens, the variable phase difference element configured to convert a polarization state of each of the first light and the second light.

2. The lighting device according to claim 1 further comprising a polarizer over the variable phase difference element, the polarizer configured to transmit one of the first light and the second light from the variable phase difference element and not to transmit another of the first light and the second light.

3. The lighting device according to claim 2, wherein the focal length +f is between the variable phase difference element and the polarizer.

4. The lighting device according to claim 2, wherein the focal length +f is between the geometric phase lens and the variable phase difference element.

5. The lighting device according to claim 1 further a lens between the light source and the geometric phase lens.

6. The lighting device according to claim 1, wherein the variable phase difference element is one of a plurality of variable phase difference elements included in a variable phase difference element unit.

7. The lighting device according to claim 1, wherein the light source is one of a plurality of light sources included in a light source unit.

8. The lighting device according to claim 1, wherein the geometric phase lens is one of a plurality of geometric phase lenses included in a geometric phase lens unit.

9. The lighting device according to claim 1, wherein the geometric phase lens comprises a first liquid crystal.

10. The lighting device according to claim 1,
wherein the variable phase difference element comprises a second liquid crystal, and
wherein a phase difference of the variable phase difference element is changed according to a magnitude of a voltage applied to the second liquid crystal.

11. A display device comprising:
at least one lighting device; and
a display panel over the at least one lighting device,
wherein the at least one lighting device comprises:
a light source;
a geometric phase lens over the light source, the geometric phase lens configured to separate an incident light into a first light having a focal length +f and a second light having a focal length −f; and
a variable phase difference element over the geometric phase lens, the variable phase difference element configured to convert a polarization state of each of the first light and the second light,
wherein the display panel is arranged to face the at least one lighting device.

12. The display device according to claim 11, wherein the display panel comprises a liquid crystal cell.

13. The display device according to claim 11, wherein the at least one lighting device comprises a plurality of lighting devices.

14. The display device according to claim 13, wherein the at least one variable phase difference element comprises a single variable phase difference element.

15. A display device comprising:
a display panel;
a plurality of geometric phase lenses arranged to face the display panel;
at least one variable phase difference element between the display panel and the plurality of geometric phase lenses, the at least one variable phase difference element configured to vary a phase difference of a light; and
at least one light source configured to irradiate the light incident on the plurality of geometric phase lenses.

16. The display device according to claim 15,
wherein the at least one variable phase difference element comprises a plurality of variable phase difference elements, and
wherein one of the plurality of geometric phase lens faces one of the plurality of variable phase difference elements.

17. The display device according to claim 15,
wherein one of the plurality of geometric phase lenses faces one of the plurality of light sources.

18. The display device according to claim 15,
wherein the plurality of geometric phase lenses comprises a first geometric phase lens and a second geometric phase lens, and
wherein an incident direction of a light that enters the display panel through the first geometric phase lens is different from an incident direction of a light that enters the display panel through the second geometric phase lens.
